(19) United States
(12) Patent Application Publication
(10) Pub. No.: US 2008/0244514 A1
(43) Pub. Date: Oct. 2, 2008

(54) Scriptable object model for network based services

(75) Inventors: Israel Hilerio, Redmond, WA (US); Eric B. Watson, Redmond, WA (US); Lingan Satkunanathan, Kirkland, WA (US); Gary Purchase, Bothell, WA (US); Shadi Ashkar, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/731,206

(22) Filed: Mar. 29, 2007

(51) Int. Cl. G06F 9/44

(52) U.S. Cl. 717/115

(57) ABSTRACT

A scripting model may include links to web based services by including an interface associated with each web based service. The interface may perform various functions used to exchange information with a web based service, such as discovery, addressing, connection, configuration, authentication, and other functions. The web based service may be used in a similar manner as a local service within the scripting model, including automatic memory management, bounds checking, data translation, and other features of scripting.

### BACKGROUND

Scripting languages may be used for a host of administrative functions in a computer system. Scripting languages enable diverse pre-existing components to be connected in a way to accomplish a new related task. In many operating systems, various components and services within a computer system may be made available within a scripting interface.

Services located outside a computer system, including services provided over a web-based interface, are often difficult to interface, and do not easily lend themselves to a scripting interface.

### SUMMARY

A scripting model may include links to web based services by including an interface or adapter associated with each web based or other remote service. The interface may perform various functions used to exchange information with a remote service, such as discovery, addressing, connection, configuration, authentication, and other functions. The remote service may be used in a similar manner as a local service within the scripting model, including automatic memory management, bounds checking, data translation, and other features of scripting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a scripting system for various services.

FIG. 2 is a diagram of an embodiment showing a connection to a remote service and various components that may be used.

FIG. 3 is a flowchart of an embodiment showing a method for some adapter functions.

FIG. 4 is a flowchart of an embodiment showing a method for installing an adapter.

### DETAILED DESCRIPTION

Web-based or other remote services are made available to a scripting environment for administrative and other tasks by providing an adapter for each remote service. The adapter may include discovery, connectivity, and other tasks that enable the web-based service to behave like a local service within the scripting environment.

A scripting environment may be a command line interface, an interpreter for interpreting a predefined script, or any other scriptable interface.

Communication and data interface functions are provided for each web-based or other remote service made available in the scripting interface. In some embodiments, a client side interface may operate on the same device as the scriptable interface to execute some or all of the communication and data interface functions for the service, while in other embodiments some of the communication and data interface functions may be performed by the remote service.

The web-based or other remote services provided through a network connection may adhere to predefined data types so that data may be smoothly transferred between services for both local and network based services.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

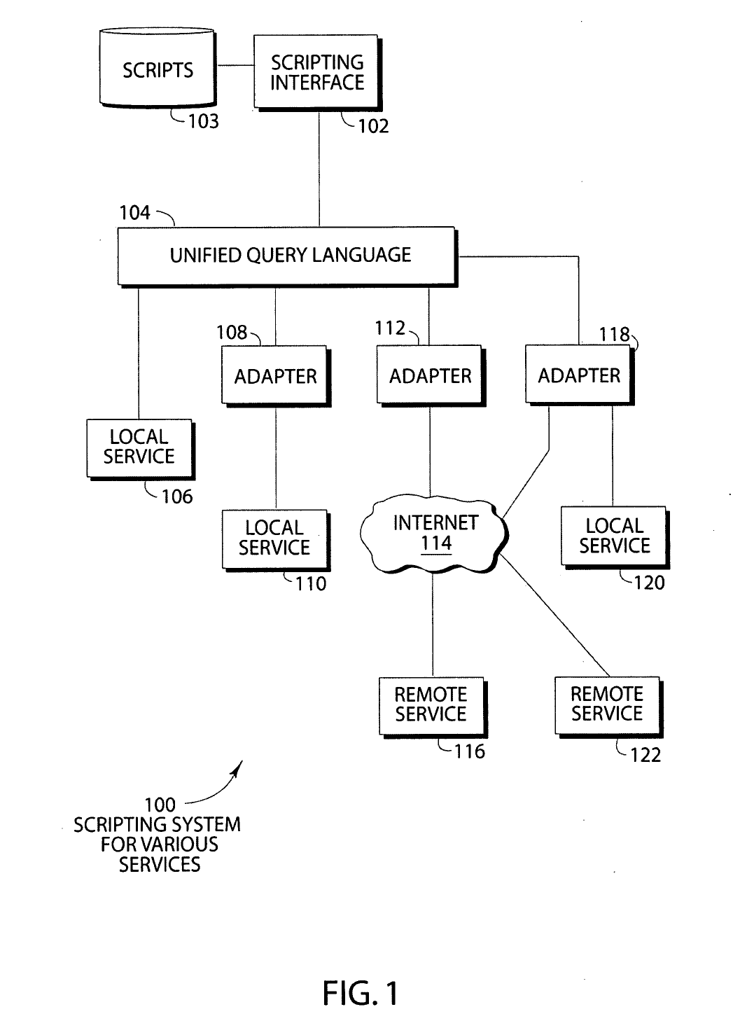

FIG. 1 is a diagram of an embodiment 100 showing a scripting system for various services. The embodiment 100 illustrates how several different services may be combined and operated in a scripting interface. These services include services operating on a local device as well as services available through the Internet, including web-based services.

The scripting interface 102 may be a command line or other interface that may be able to execute single command-line scripts or more complex predefined scripts 103 that may include branching or other logic. The scripting interface 102 may enable different services to be connected using various mechanisms, such as a pipeline command. In order for the services to inter-operate, a unified query language 104 or unified object model may be applied to or used by each service. The unified query language 104 or unified object model may define the types of input and output data as well as provide automatic memory management, bounds checking, and other functions.

Many different scripting languages and interfaces may be used. In some embodiments, a single command line interface may be used to interactively perform individual tasks. Other embodiments may execute a predefined text based script without a command line interface. Various implementations may also use different command syntaxes and command names.

Some scripting environments may have a shell or other command line type interface while other scripting environments may comprise a language that is interpreted at runtime either as a standalone application or as embedded in an application program. Some scripting environments may be application specific and may perform various functions within another application, including scripts within web pages or scripts that may be used to extend or modify games or business applications.

The scripting interface 102 is a mechanism by which disparate services may be connected to provide useful functions. The output of one service may be sent to another service to connect the two and perform complex functions that otherwise would be difficult to program. Common scripting languages may use a pipeline command to direct the output of one service to the input of another.

A local service 106 may be directly called by the scripting interface 102 and may be a service available on the host device operating the scripting interface 102. In some instances, the local service 106 may be an executable file that is executed directly by the scripting interface 102 when called. An example of a local service 106 may be a directory command that displays the contents of a directory. In other instances, the local service 106 may be a process that is operational on a system and may respond to commands. An example may be a SQL server application that may be directly queried using a scripting interface 102.

A local service 110 may be connected to the scripting interface through an adapter 108. The adapter 108 may perform various tasks so that the local service 110 may operate with the scripting interface 102. The adapter 108 may perform tasks such as data translation, communication with the local service 110, or other functions that enable the local service 110 to comply with the unified query language 104.

The pipeline command or other connection mechanisms may make it possible to connect two different services together, including remote services. For example, a script command may call a function that returns a list of users and connect the output of the first function with an input to a remote function, such as adding the list of users as new users to a remote Customer Resource Management system that is a web based application. The pipeline or other connection mechanism may connect the two services, one local and one remote, using a very simple command structure. Many of the complexities of translating between the two services may be handled within the unified query language 104. Further, the complexities of connecting to the remote service, authenticating with the service, and translating data between the scripting interface 102 and the remote service may also be transparent to the user.

An adapter 112 may provide a connection through the Internet 114 to a remote service 116. The remote service 116 may be any type of service, including web-based services. The adapter 112 may provide several functions for integrating the remote service 116 into the scripting interface 102. Such functions may include connection, authentication, discovery, as well as various translation functions.

An example of a remote service 116 may be a Customer Resource Management (CRM) system that is provided over the Internet 114. The CRM system may have a web interface through which a user may interact with the system using a web browser. The CRM system may also have an interface through which the adapter 112 may perform various functions. A limitless number of other services, functions, and operations may be performed by a remote service 116.

In some embodiments, the adapter 112 may make the same set of functions available to the scripting interface 102 as a web-based interface may enable. In other embodiments, the adapter 112 may make a greater number of commands and functions available, while in still other embodiments, a reduced command set may be available. Some embodiments may have a specialized command set available through the scripting interface 102 that is not available through other interfaces. Such specialized commands may include various administrative tasks that are not normally available to another user of the remote service 116.

The adapter 112 may enable a remote service 116 to be operated and manipulated within the scripting interface 102 with the same tools and as if the service was a local service 106. In some embodiments, the remote service 116 may have several different functions or commands that may be executed through the scripting interface 102. The adapter 112 may be configured to recognize commands intended for the remote service 116 and communicate those commands to the remote service 116. When a command is recognized by the adapter 112, a session may be established with the remote service 116 to process the command.

The remote service 116 may have various connection requirements, including user authentication which may include passwords, digital signatures, or digital certificates that may authenticate a specific user or session. Additional functions within the service 116 and coordinated with the adapter 112 may authorize the user to perform specific functions. In some embodiments, the remote service 116 may have an anonymous login or other connection mechanism that does not require authentication and authorization.

Adapter 118 may connect the scripting interface 102 with a local service 120 and a remote service 122 that is available through the Internet 114. Adapter 118 may provide hybrid services that have a local and remote component. Some commands or functions made available through the scripting interface 102 may entail a portion of which to be performed by a local service 120 and another portion by a remote service 122. An example of such a service may involve a query to a Customer Resource Management system that returns a cross reference of an Internet database with a local database of customer names.

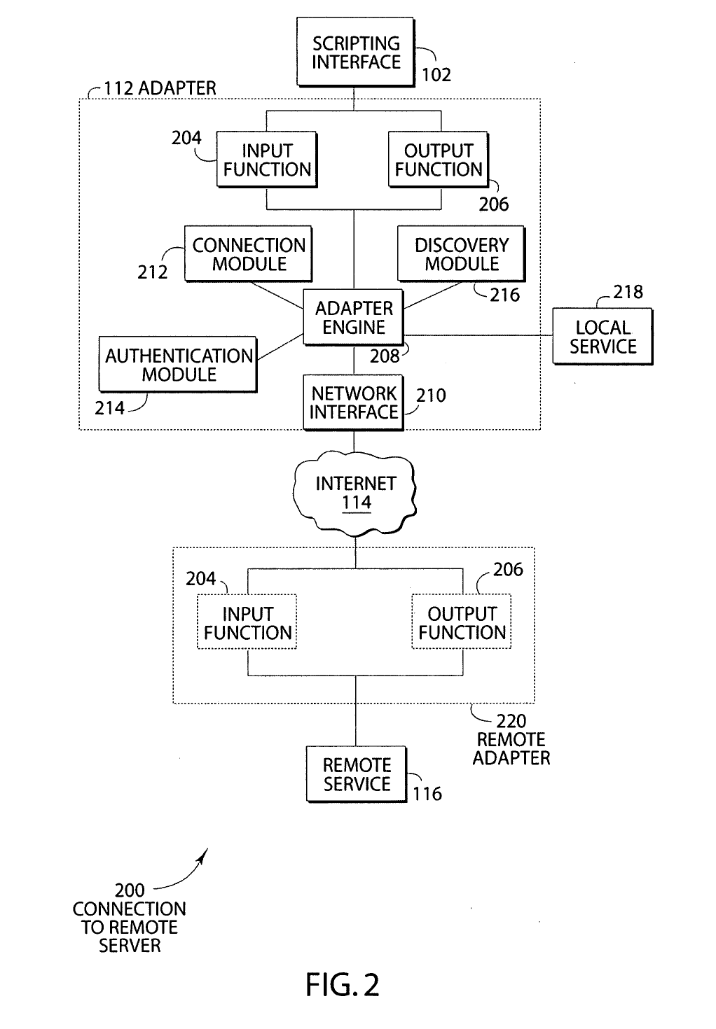

FIG. 2 is a diagram illustration of an embodiment 200 showing a functional architecture for a connection to a remote server. Embodiment 200 shows a detailed example of the mechanisms that may be used to connect a scripting interface 102 and an adapter 112 to a remote service 116 through the Internet 114.

The adapter 112 contains an input function 204 and output function 206 that may translate incoming and outgoing data, respectively, between the scripting interface 102 and the remote service 116. The input function 204 and output function 206 may translate, format, or provide any changes to the incoming or outgoing data. In some instances, the input function 204 and output function 206 may provide simple data formatting or configuration of the data, while in other instances, complex manipulations, calculations, or other functions may be applied to the data.

In some embodiments, an input function 204 or output function 206 may combine data from two or more sources. For example, an output function 206 may combine data from two database queries on the remote server 116 into a data format that is used in the scripting interface 102. Another example may combine the output of the remote service 116 with that of a local service 218 to produce a single set of output for the scripting interface 102. In another example, a single function call from the scripting interface 102 may be translated into two or more separate commands some of which may be performed by the remote service 116 and others by the local service 218.

In some embodiments, the input function 204 and output function 206 may reside in a remote adapter 220 that operates on a host device for the remote service 116 or another device connected to the Internet 114. The functions of translating, aggregating, interpreting, formatting, or otherwise manipulating data to pass between the scripting interface 102 and the remote service 116 may also be performed by two or more incremental translation functions. In such an embodiment, a portion of the input function 204 and output function 206 may be performed in the adapter 112 and a portion in the remote adapter 220.

In some embodiments, the functions of the input function 204 and output function 206 may be inherent in the remote service 116 when the remote service 116 is designed to operate with the scripting interface and no translation or formatting is used.

The adapter engine 208 may coordinate the various functions of the adapter 112. The adapter engine 208 may detect that a command for the remote service 116 has been called from the scripting interface 102 and may perform various tasks for making a connection to the remote service 116 and returning data to the scripting interface 102. Examples of such tasks may include discovering the location or address for the remote service 116, making a connection over the Internet 114 and authenticating with the remote service 116.

The adapter engine 208 may interface with the scripting engine 102 as would a local service. The adapter engine 208 may connect to the scripting interface 102 with a predefined set of commands for which the adapter engine may be configured to acknowledge and process. In some embodiments, the adapter 208 may receive commands that are unrecognized by other local services within the scripting engine and may attempt to find a remote service 116 that may process the command.

An adapter engine 208 may have a set of predefined commands that may be established when an adapter 112 is installed to a system that hosts the scripting interface 102. In some embodiments, an adapter 112 may be installed for each remote service 116. In other embodiments, an adapter 112 may be used for two or more remote services 116. In such an embodiment, the supported commands for each remote service 116 may be added to an existing adapter 112 when a new remote service 116 is installed.

When an adapter engine 208 is designated to receive unrecognized commands from a scripting engine 102, the adapter engine may perform a search of the Internet 114 or of a database of remote services to determine if a command may be processed by a remote service. In some embodiments, an adapter 112 may maintain a local database that may contain several remote services and the various commands supported by the remote services. When a command is received by the adapter 112, the command may be used to query the database to determine an appropriate remote service to execute the command. In similar embodiments, an adapter engine 208 may be configured to connect to a remote database to determine a remote service that may execute a particular command.

The discovery module 216 may perform discovery operations prior to a command from the scripting interface 102 and in response to a function call from the scripting interface 102.

Before a command is issued by the scripting interface 102, the discovery module 216 may contact the remote service 116 and download a set of commands that are supported by the remote service 116. In some cases, a set of commands may be a standard set of available commands for the remote service, while in other cases, a set of commands may be those particular commands for which a user is authorized. For example, a user may pay a subscription fee or have an account that enables the user to access a limited portion of the command set of the remote server. Those commands for which the user has authorization may be available within the scripting interface.

When a function call is received from the scripting interface 102, the discovery module 216 may determine the appropriate mechanism for contacting the remote service 116. In some instances, the discovery module 216 may search the Internet 114 for a service that matches a function call.

For example, a command from the scripting interface 102 may include a reference to a service that is not available as a local service. The discover module 216 may search a database of remote services to determine if a remote service is available and retrieve addresses or other information that may be used to connect to the remote services.

In another example, a command from the scripting interface 102 may include a website address, remote server Uniform Resource Locator (URL), unique name, or other information that may be used by the discovery module 216 to find the remote service 116. In such an example, the discovery module 216 may receive an address or other locator for a remote service 116 to determine a proper address or other connection information for the remote service 116. In some instances, the discovery module 216 may contact an intermediary device that may provide an updated address or a specific URL for a particular remote service.

In some instances, a remote service 116 may have a single URL or address that may respond to many different commands. In other instances, each command may have a specific URL that is used for each command. Additionally, a URL may have a syntax by which an adapter 112 may pass data to the remote service 116.

A connection module 212 may perform the function of establishing a connected session with the remote service 116. The connection module 212 may establish a connection with the remote service 116 in different manners, depending on the precise embodiment. Some embodiments of a connection module 212 may connect to the remote service 116 through a dialup connection, a direct Internet connection, or any other mechanism. In each case, the connection module 212 may establish a communications session by activating the appropriate hardware, performing handshaking, or other steps. The connection module 212 may also establish an encrypted or secure connection between the adapter 112 and the remote service 116.

The authentication module 214 may provide an automated authentication function for the remote service 116. Authentication functions may include signing into the remote service 116 with a specific user identification, providing a password, sending a digitally signed document of authenticity, credentials, or any other security or identification measures. In embodiments where a remote service 116 may be a purchased service or may handle sensitive data, various forms of authentication may be used. In some instances, authentication may be used by a remote server 116 to determine which functions, if any, may be provided for the adapter 112.

The network interface 210 may be any type of interface to any type of network. In some embodiments, the network interface 210 may be connected to a hardwired Ethernet connection to a local area network, and the local area network may have a gateway to the Internet 114. In other embodiments, the network interface 210 may be a wireless connection to a wireless access point that may provide connection to the Internet 114. Such a device may be a laptop computer with wireless connection or a handheld mobile telephone device using a cellular connection to a network. Each embodiment may have a different implementation of a network connection.

In some instances, the remote service 116 may be a web-based service. Such services may have an application programming interface (API) that is exposed so that one device, such as a device executing the adapter 112, may be able to communicate with and execute instructions with a remote service 116.

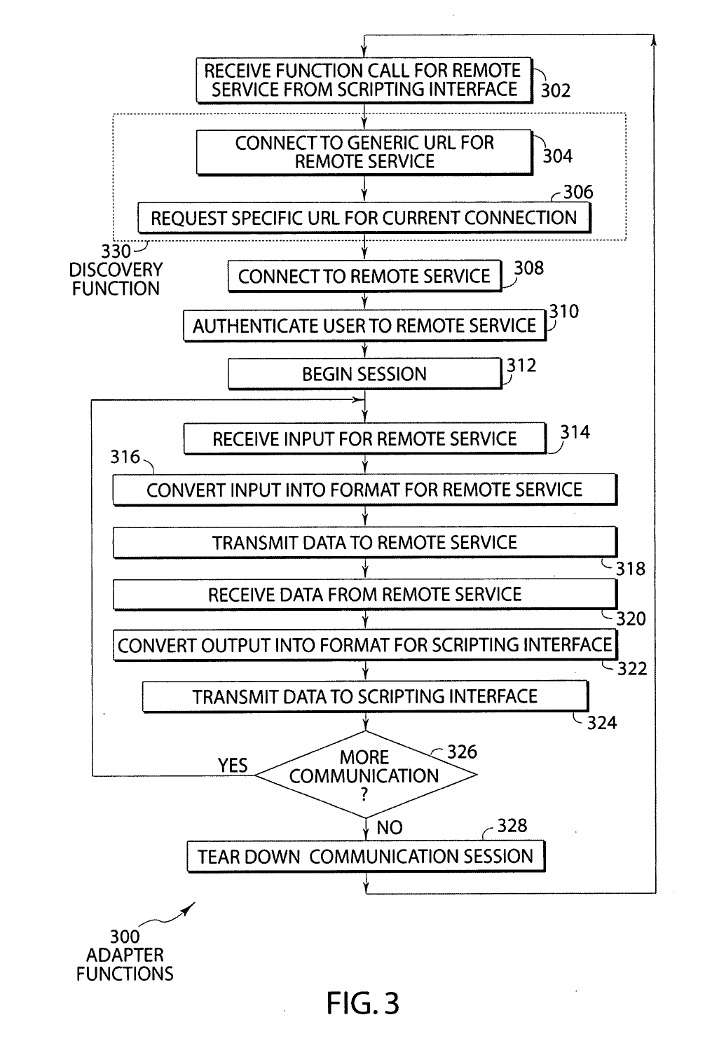

FIG. 3 is a flowchart illustration of an embodiment 300 showing a method of some adapter functions. Embodiment 300 shows a process of receiving a function call, performing a discovery function, connecting to the remote service, and communicating with the remote service to receive some results. The results are passed back to the scripting interface. Other embodiments may have adapters configured in different manners and configured to perform different actions.

A function call is received from a scripting interface for a remote service in block 302. An adapter may be configured to integrate into a scripting interface as a local service to the scripting interface. In some embodiments, the adapter may be an executable program that is launched when a command for the adapter is issued. In other embodiments, the adapter may be a process that is executing on the device. An adapter may be configured with a specific set of commands that the adapter may execute. In other embodiments, an adapter may be configured to receive any command or a large set of commands and attempt to discover and connect to a remote service that may service the command.

A discovery function 330 may be performed that includes connecting to a generic URL for a remote service in block 304 and requesting a specific URL for a current situation in block 306. The discovery function 330 may be used in different scenarios to perform different tasks.

In a first scenario, an adapter may be preconfigured to respond to a specific command. When the command is issued, the adapter may connect to a generic URL for the remote service in block 304 to determine that the remote service exists and to determine if a different URL in block 306 is to be used for the command.

In a second scenario, an adapter may or may not be preconfigured to respond to a specific command. The command transmitted in block 302 may be an arbitrary command for which the adapter may search a database of commands in block 304 to determine a URL or other address for a remote service that may respond to the command. The generic URL in block 304 may be a search engine that searches the Internet for remote services. In other cases, the generic URL in block 304 may be a database of remote services that may contain specific URLs for specific commands or groups of commands.

A connection is made to the remote service in block 308. Establishing a connection between an adapter and a remote service may depend on various factors, and may include setting up a connection using low level hardware protocols as well as higher level protocols to establish a session. An example of a session may be one established using a session layer as defined in the Open Systems Interconnection (OSI) Reference Model. The specifics of each embodiment may vary greatly with the hardware and software in each embodiment. In some embodiments, the connection established in block 308 may include creating an encrypted or secure connection between the adapter and remote service.

A user may be authenticated to the remote service in block 310. In some instances, the authentication of block 310 may include connecting with a user identification and password, transmitting a digitally signed certificate, providing an encryption key, transmitting various credentials, or any other mechanism by which the user of the adapter may be authenticated. Authentication may provide a mechanism by which a remote service may verify that the user has authority or access to a specific function. In some instances, an un-authenticated user may be permitted to access a limited function set from a remote service while an authenticated user may be given access to a full set of functionality. In some instances, a user may be authenticated and given access to a specific subset of functionality based on a subscription value or some other factor.

A session between an adapter and a remote service is begun in block 312. Input from the scripting interface is received in block 314 and converted into a format for the remote service in block 316. The data are transmitted to the remote service in block 318 and data received from the remote service in block 320. The received data are converted into a format for the scripting interface in block 322 and the data are transmitted to the scripting interface in block 324.

Each embodiment of a scripting interface and remote service may have a particular language, syntax, data format, and data type for data transfer into and out from each component. The conversion of data in blocks 316 and 322 may be any type of transformation, analysis, formatting, aggregation, or other manipulation of the data. In some embodiments, the conversion of data in blocks 316 and 322 may encompass complex calculations, aggregation of data from multiple sources, or other processing.

If more communication is to be performed in block 326, the process returns to block 314. Otherwise, the communication session may be torn down in block 328 and the process may return to block 302. In some embodiments, a communication session may be established for a period of time and, after a period of inactivity, the session may be terminated. Such an embodiment may be useful when the process of discovery, connection, and authentication is complex or time consuming.

In some embodiments, each communication between an adapter and a remote service may create a single communication session. In some embodiments, a communication session may be established for data transmitted from the adapter to the remote service and another communications session established for the communication from the remote server to the adapter.

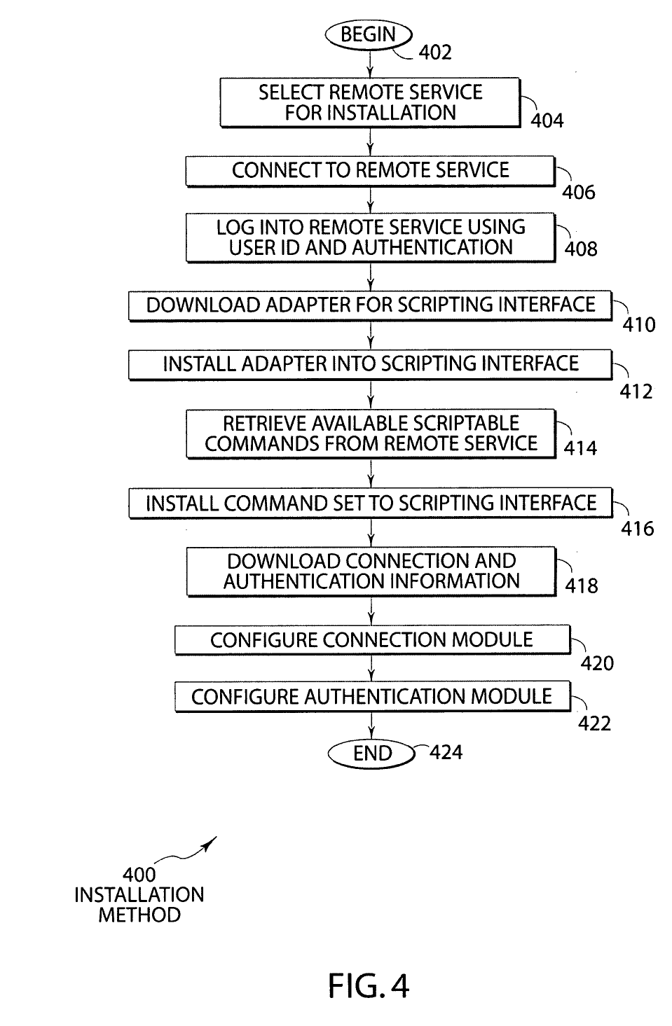

FIG. 4 is a flowchart illustration of an embodiment 400 showing a method for installing an adapter. Embodiment 400 illustrates a method whereby a remote service may provide many different components during the installation process of the remote service into a scripting interface.

The process begins in block 402. A remote service is selected for installation in block 404 and a connection is made to the remote service in block 406. A user may log into the remote service using any user identification and authentication required by the remote service in block 408.

In some embodiments, a user may connect to and authenticate with a remote service in blocks 406 and 408 through an interface such as a web browser or other application. In such an embodiment, the user may perform several additional configuration actions with the remote service, including subscribing to the service, selecting specific features, or other functions. In other embodiments, an automated connection and authentication may be performed in blocks 406 and 408.

After logging in and authenticating, an adapter may be downloaded in block 410 and installed into a scripting interface in block 412. In some embodiments, a scripting interface may have a mechanism by which various services may be installed. In some cases, installing a service may consist of copying the adapter into a specific directory or giving the adapter a specific name. In other embodiments, a remote service may be installed by configuring various parameters within the scripting interface. Other embodiments may have different mechanisms by which an adapter may be added to a system so that a scripting interface may recognize the adapter or transmit commands to the adapter.

A set of available commands may be downloaded in block 414 and installed into the scripting interface in block 416. In some embodiments, a scripting interface may operate with a defined set of functions or commands. The process of blocks 414 and 416 may retrieve those commands and make them available to the scripting interface. Each scripting interface may have a different manner for handling additional commands. In some embodiments, blocks 414 and 416 may not be performed.

Connection and authentication information may be downloaded in block 418 and used to configure a connection module in block 420 and an authentication module in block 422. The process may end in block 424.

Embodiment 400 is an example of an installation process that downloads an adapter, which may be generic, and some user-specific customizations such as the specific list of available commands and the connection and authentication information. Such an installation process may be performed by connecting to a remote service provider using a web browser and configuring the service, then downloading the adapter and customized modules.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a function call for a service through a scripting interface, said service being provided over a network connection;
performing a connection function to connect to said service;
receiving input data from said scripting interface;
transmitting said input data to said service;
receiving output data from said service; and
transmitting said output data to said scriptable interface.

2. The method of claim 1 further comprising:
performing a discovery function for said service to determine a network address for said service.

3. The method of claim 1 further comprising:
performing an authentication function with said service.

4. The method of claim 1, said network connection comprising a connection through the Internet.

5. The method of claim 1, said service being a web-based service.

6. The method of claim 1, said scripting interface comprising a command line interface.

7. The method of claim 1, said scripting interface comprising an interpreter.

8. The method of claim 1, said scripting interface adapted to interpret a predefined script.

9. The method of claim 1 further comprising translating said input data into a first data format, said first data format being compatible with said service.

10. The method of claim 1 further comprising translating said output data into a second data format, said second data format being compatible with said scriptable interface.

11. A computer readable medium comprising computer executable instructions adapted to perform the method of claim 1.

12. A scripting system comprising:
a scripting interface adapted to receive a script and interpret said script, said scripting interface being operable on a client device;
a service operable over a network connection, said service comprising:
an input function adapted to accept input data in a first predefined format; and
an output function adapted to transmit output data in a second predefined format; and
a connection module adapted to connect said client device to said service.

13. The scripting system of claim 12, said input function comprising a data translator adapted to operate on said client device.

14. The scripting system of claim 12, said first predefined format and said second predefined format being identical.

15. The scripting system of claim 12 further comprising an authentication module adapted to authenticate a user to said service.

16. A network-based service comprising:
an interface to a network;
an input function adapted to accept input data;
an output function adapted to transmit output data;
a client adapter for a scripting interface, said client adapter being operable on a client device and adapted to:
receive a function call for a service through a scripting interface, said service being provided over a network connection;
perform a connection function to connect to said service;
receive input data from said scripting interface;
transmit said input data to said service;
receive output data from said service; and
transmit said output data to said scriptable interface.

17. The network-based service of claim 12, said client adapter further adapted to:
perform a discovery function for said service to determine a network address for said service.

18. The network-based service of claim 12, said client adapter further adapted to:
performing an authentication function with said service.

19. The network-based service of claim 12, said client adapter further adapted to:
translate said input data into a first data format, said first data format being compatible with said service.

20. The network-based service of claim 12, said client adapter further adapted to:
translate said output data into a second data format, said second data format being compatible with said scriptable interface.
